(19) United States
(12) Patent Application Publication
(10) Pub. No.: US 2026/0064323 A1
(43) Pub. Date: Mar. 5, 2026

(54) IMAGE FORMING DEVICE

(71) Applicant: SHARP KABUSHIKI KAISHA, Sakai City (JP)

(72) Inventor: Rumiko MORIMOTO, Sakai City (JP)

(21) Appl. No.: 19/309,158

(22) Filed: Aug. 25, 2025

(30) Foreign Application Priority Data
Sep. 3, 2024 (JP) 2024-151634

(51) Int. Cl. G06F 3/12; G03G 15/00; H04N 1/00

(52) U.S. Cl. CPC G06F 3/1204; G03G 15/5016; G03G 15/5087; G06F 3/1208; G06F 3/121; G06F 3/1256; H04N 1/0044; G06F 3/1292; H04N 2201/0094

(57) ABSTRACT

The present disclosure provides an image forming system capable of correcting a print instruction when an image forming device receives a print command from a user terminal. In the user terminal, when a terminal operation acceptor has accepted a setting indicating whether or not to transmit all-image data of a file subjected to printing that includes the image data pertaining to the print command, the user terminal causes a terminal communicator to transmit the all-image data including the image data pertaining to the print command, and print settings including a setting to transmit the all-image data. In the image forming device, when the print settings received by a communicator include a setting to transmit the all-image data, the image forming device causes an operation panel to display a preview screen so as to be capable of accepting a correction command of the image data pertaining to the print command.

### CROSS-REFERENCE TO RELATED APPLICATION

The present application claims priority from Japanese Application JP2024-151634, the content to which is hereby incorporated by reference in to this publication.

### BACKGROUND OF THE INVENTION

### Field of the Invention

The present disclosure relates to an image forming system, and more specifically, to an image forming system comprising a user terminal, and an image forming device that receives a print job instruction from the user terminal via a network.

### Description of the Background Art

In recent years, with the adoption of wireless LAN in image forming devices such as MFPs (multifunction peripherals), it has become possible to transmit print data to an image forming device installed in a location away from a terminal, and execute printing. As a result, it has also become possible to construct an image forming system in which the image forming device is installed in a location that is far away from the terminal, such as a case where the terminal is installed on the second floor and the image forming device is installed on the first floor.

In such an image forming system, a user may sometimes issue a print instruction to the image forming device using a printer driver of the terminal with the intention of printing only specific pages, but mistakenly issue an instruction to print all pages. In this case, the user only realizes the mistake in the print instruction upon seeing the paper that has been output from the image forming device.

When the user notices such a mistake in the print instruction, it is possible to cancel the printing by pressing a cancel button on an operation panel of the image forming device. However, in a case where the print instruction has issued from a terminal that is far away from the image forming device, by the time the user reaches the image forming device and notices the mistake in the print instruction, and attempts to cancel the printing, it is often too late, resulting in wasted paper and toner.

Conventionally, as a technique to prevent such waste of paper and toner due to a mistake in a print instruction, for example, an image forming device has been proposed in which, during continuous printing on the reverse side of used paper, in which a plurality of images are consecutively formed the reverse side of the used paper, a controller temporarily stops the printing operation after the first sheet is printed.

Furthermore, a printing device has also been proposed in which printing is resumed when the user performs an operation to resume printing on an inputter after the printing operation has been temporarily stopped, or printing is resumed after a predetermined time has elapsed since the printing operation was temporarily stopped.

### SUMMARY OF THE INVENTION

However, while the conventional methods can prevent execution of printing based on an incorrect print instruction by temporarily stopping the printing operation in the image forming device, in order to perform correct printing, the user needs to return to the terminal and issue the print instruction again, which cannot be said to be highly convenient for the user.

The present disclosure has been made in consideration of the above circumstances, and an object thereof is to provide an image forming system capable of more easily correcting a mistake in a print instruction than in a conventional system when an image forming device receives a print command from a user terminal via a network.

An image forming system according to the present disclosure comprises a user terminal and an image forming device connected via a network, wherein the user terminal includes a terminal operation acceptor that accepts a print command issued with respect to the image forming device a terminal communicator that transmits image data and print settings pertaining to the print command, and a terminal controller that controls the terminal operation acceptor and the terminal communicator the image forming device includes a communicator that receives the print command an image former that forms an image based on the image data and the print settings pertaining to the print command an operation panel that displays various information and accepts a command from a user, and a controller that controls the communicator, the image former, and the operation panel the terminal operation acceptor accepts a setting indicating whether or not to transmit all-image data of a file subjected to printing that includes the image data pertaining to the print command the terminal controller, in a case where the terminal operation acceptor has accepted the setting to transmit the all-image data, causes the terminal communicator to transmit the all-image data including the image data pertaining to the print command, and the print settings including the setting to transmit the all-image data, and the controller, in a case where the print settings received by the communicator include the setting to transmit the all-image data, causes the operation panel to display a preview screen of the image data so as to be capable of accepting a correction command of the image data pertaining to the print command.

In the present disclosure, the “image forming device” is a device that forms and outputs images, such as a copying machine or a multifunction peripheral having a copy function, including a printer using an electrophotographic method for image formation using toner, or an MFP that also includes functions other than copying.

The “user terminal” is not limited to a personal computer (PC), and can also be a mobile information terminal such as a smartphone or tablet, an electronic blackboard, an information display, or the like.

According to the present disclosure, when the image forming device receives a print command, in a case where all-image data including the image data pertaining to the print command has been received, because a preview screen of the image data is displayed so as to be capable of accepting a correction command of the image data pertaining to the print command, it is possible to realize an image forming system capable of more easily correcting a mistake in a print instruction than in a conventional system.

### BRIEF DESCRIPTION OF THE DRAWINGS

FIG. 1 is an explanatory diagram showing an example of the configuration of an image forming system of the present disclosure.

FIG. 2 is a block diagram showing a schematic configuration of the digital multifunction peripheral in FIG. 1.

FIG. 3 is a block diagram showing a schematic configuration of the user terminal in FIG. 1.

FIG. 4 is a flowchart showing an example of transmission processing of a print job to the digital multifunction peripheral 1 in a printer driver of the user terminal in FIG. 1.

FIG. 5 is an explanatory diagram showing an example of a print setting screen of the printer driver displayed on a display of the user terminal shown in FIG. 1.

FIG. 6 is an explanatory diagram showing an example of printing processing in the digital multifunction peripheral shown in FIG. 1.

FIG. 7 is an explanatory diagram showing an example of a print job list displayed on the display of the digital multifunction peripheral shown in FIG. 1.

FIG. 8 is an explanatory diagram showing an example of a preview screen displayed on the display of the digital multifunction peripheral shown in FIG. 1.

FIG. 9 is an explanatory diagram showing an example of a print setting correction screen displayed on the display of the digital multifunction peripheral shown in FIG. 1.

FIG. 10 is an explanatory diagram showing an example of a confirmation screen for single-page printing in the print setting correction screen displayed on the display of the digital multifunction peripheral shown in FIG. 1.

FIG. 11 is an explanatory diagram showing an example of a confirmation screen for all-pages printing in the print setting correction screen displayed on the display of the digital multifunction peripheral shown in FIG. 1.

FIG. 12 is an explanatory diagram showing an example of selecting a print start page and a print end page in the print setting correction screen displayed on the display of the digital multifunction peripheral shown in FIG. 1.

FIG. 13 is an explanatory diagram showing an example of a confirmation screen for printing a specific page in the print setting correction screen displayed on the display of the digital multifunction peripheral shown in FIG. 1.

### DESCRIPTION OF THE PREFERRED EMBODIMENTS

Further, preferred aspects of the present disclosure will be described.

The image forming system according to the present disclosure may be configured such that the controller, in a case where the communicator has received the all-image data including the image data pertaining to the print command, causes the operation panel to display a preview screen of the image data pertaining to the print command, and the correction command includes at least one of a page-specifying command of the image data, an all-pages print command of the image data, or a single-page print command of the image data displayed on the preview screen.

As a result, when the image forming device receives a print command from the user terminal via a network, and receives the all-image data including the image data pertaining to the print command, the controller causes a preview screen of the image data pertaining to the print command to be displayed, and the correction command includes at least one of a page-specifying command of the image data, an all-pages print command of the image data, or a single-page print command of the image data displayed on the preview screen. Therefore, an image forming system capable of more easily correcting a mistake in a print instruction compared to a conventional system can be realized.

In the image forming system according to the present disclosure, the image forming device may further include a storage that stores all data pertaining to the print command in a predetermined spool area, wherein the controller, in a case where a remaining capacity of the spool area becomes less than a predetermined capacity, even when the communicator has received the all-image data including the image data pertaining to the print command, causes the image former to form an image based on the image data and the print settings.

As a result, when the image forming device receives a print command from the user terminal via a network, and the remaining capacity of a spool area becomes less than a predetermined capacity, even when the all-image data including the image data pertaining to the print command has been received, an image is formed based on the image data and the print settings. Therefore, an image forming system with a reduced system load compared to a conventional system can be realized.

The image forming system according to the present disclosure may be configured such that the terminal controller, in a case where the all-image data of the file subjected to printing in the print command consists of only one page, even when the terminal operation acceptor has accepted a setting to transmit the all-image data, causes the terminal communicator to transmit only the image data pertaining to the print command.

As a result, when the image forming device receives a print command from the user terminal via a network, and the all-image data of the file subjected to printing in the print command consists of only one page, even when a setting has been accepted to transmit the all-image data, the terminal communicator only transmits the image data pertaining to the print command. Therefore, an image forming system with a reduced system load compared to a conventional system can be realized.

The image forming system according to the present disclosure may be configured such that the user terminal further includes a terminal display that displays various information, wherein the terminal operation acceptor, in a case where the all-image data of the file subjected to printing in the print command consists of only one page, does not display, on the terminal display, a setting indicating whether or not to transmit the all-image data of the file subjected to printing that includes the image data pertaining to the print command.

As a result, in a case where the all-image data of the file subjected to printing in the print command consists of only one page, the terminal operation acceptor does not display a setting indicating whether or not to transmit the all-image data of the file subjected to printing that includes the image data pertaining to the print command. Therefore, an image forming system with a reduced system load compared to a conventional system can be realized.

The image forming system according to the present disclosure may be configured such that the controller, in a case where the communicator has not received the all-image data including the image data pertaining to the print command, causes the image former to form an image based on the image data and the print settings pertaining to the print command.

As a result, when the image forming device receives a print command, in a case where the all-image data including the image data pertaining to the print command has not been received, the image forming device causes the image former to form an image based on the image data and the print settings pertaining to the print command. Therefore, an image forming system capable of performing printing as in a conventional system can be realized.

Hereinafter, the present disclosure will be described in further detail with reference to the drawings.

It should be noted that the following description is illustrative in all respects and should not be construed as limiting the present disclosure.

### Embodiment 1

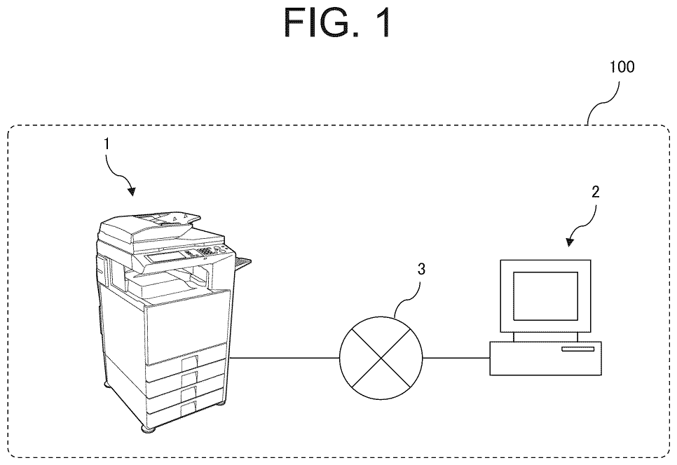

An image forming system 100, which is an embodiment of the image forming system of the present disclosure, will be described based on FIGS. 1 to 3.

FIG. 1 is an explanatory diagram showing an example of the configuration of the image forming system 100 of the present disclosure.

As shown in FIG. 1, the image forming system 100 is constituted by a digital multifunction peripheral 1 and a user terminal 2, which are connected to each other by a wired or wireless network 3.

The digital multifunction peripheral 1 is a device such as an MFP that digitally processes image data, and has a copy function, a scanner function, and a facsimile function.

The digital multifunction peripheral 1 executes jobs such as scanning, printing, copying, or image transmission (Scan to Email, Scan to Ftp) based on instructions received from a user via an operation acceptor 172 or a communicator 15.

### <Schematic Configuration of Digital Multifunction Peripheral 1>

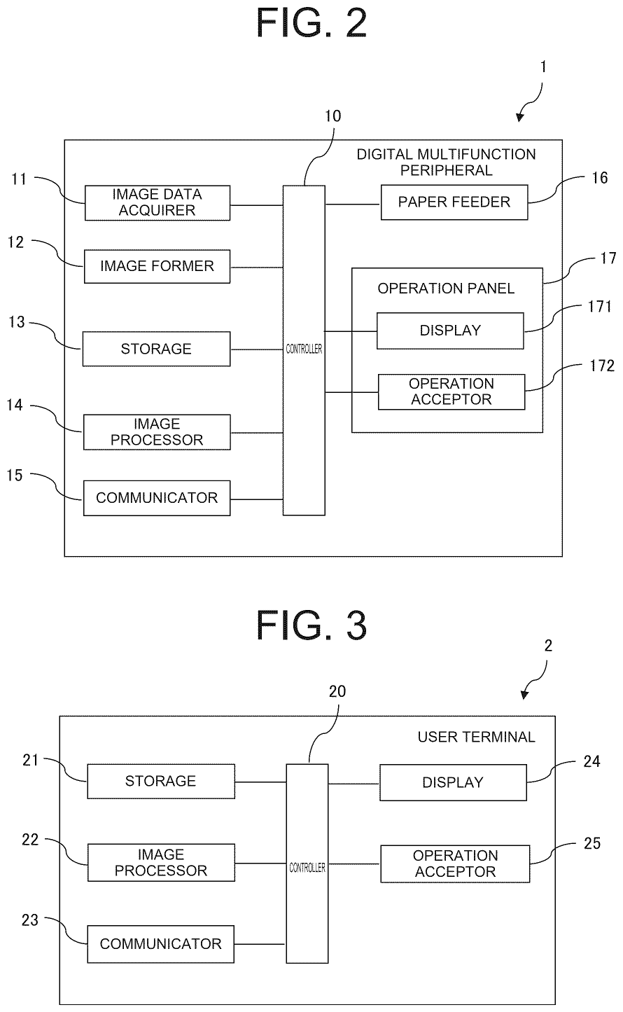

Next, a schematic configuration of the digital multifunction peripheral 1 will be described based on FIG. 2.

FIG. 2 is a block diagram showing a schematic configuration of the digital multifunction peripheral 1 shown in FIG. 1.

As shown in FIG. 2, the digital multifunction peripheral 1 includes a controller 10, an image data acquirer 11, an image former 12, a storage 13, an image processor 14, a communicator 15, a paper feeder 16, and an operation panel 17.

Hereinafter, each component of the digital multifunction peripheral 1 will be described.

The controller 10 integrally controls the digital multifunction peripheral 1, and comprises at least one CPU (Central Processing Unit), at least one SoC (System on a Chip), at least one RAM (Random Access Memory), at least one ROM (Read Only Memory), at least one control circuit, various interface circuits, and the like.

The controller 10 monitors and controls all loads, such as detection by each sensor, motors, clutches, the operation panel 17, and the like, in order to control the overall operation of the digital multifunction peripheral 1.

The image data acquirer 11 is a part that acquires image data received via the communicator 15 from an external terminal such as the user terminal 2, or a facsimile device (not shown).

The image former 12 is a part that prints and outputs image data processed by the image processor 14 onto paper.

The storage 13 is an element or storage medium that stores information necessary for realizing various functions of the digital multifunction peripheral 1, control programs, and the like. For example, semiconductor elements such as a RAM or ROM, or storage media such as a hard disk, flash storage, or SSD (Solid State Drive) are used.

Note that the programs and data may be held in different devices, such as in a configuration where the area for holding data is constituted by a hard disk drive, and the area for holding programs is constituted by a flash storage.

The image processor 14 is a part that converts a document image that has been read by the image data acquirer 11 into an appropriate electrical signal to generate image data, and processes the image data that has been input from the image data acquirer 11 according to commands such as enlargement and reduction from the operation acceptor 172 such that the image data is suitable for output.

The communicator 15 is a part that communicates with the external user terminal 2 or the like via the network 3, and receives print data such as print settings and images.

The paper feeder 16 includes a paper feeding cassette and a manual feed tray, and is a part that conveys paper stored therein to the image former 12.

The operation panel 17 is a unit provided with a liquid crystal display (LCD), and includes a display 171 and an operation acceptor 172.

The display 171 is a part that displays various information.

The display 171 is configured by, for example, a CRT display, a liquid crystal display, an EL display, or the like, and is a display device such as a monitor or line display for an operating system or application software to display electronic data such as a processing state. The controller 10 displays the operation and state of the digital multifunction peripheral 1 through the display 171.

The operation acceptor 172 is configured by a touch panel, displays information on the liquid crystal display, and is a part that accepts commands from the user through the touch panel.

### <Schematic Configuration of User Terminal 2>

Next, a schematic configuration of the user terminal 2 will be described based on FIG. 3.

FIG. 3 is a block diagram showing a schematic configuration of the user terminal 2 of FIG. 1. As shown in FIG. 3, the user terminal 2 includes a controller 20, a storage 21, an image processor 22, a communicator 23, a display 24, and an operation acceptor 25.

Hereinafter, each component of the user terminal 2 will be described.

The controller 20 integrally controls the user terminal 2, and comprises a CPU, RAM, ROM, various interface circuits, and the like.

The controller 20 monitors and controls all loads, such as detection by each sensor, the operation acceptor 25, and the like, in order to control the overall operation of the user terminal 2.

The storage 21 is an element or storage medium that stores information necessary for realizing various functions of the user terminal 2, control programs, and the like. For example, semiconductor elements such as a RAM or ROM, or storage media such as a hard disk, flash storage, or SSD are used.

Note that the programs and data may be held in different devices, such as a configuration where the area for holding data is constituted by a hard disk drive, and the area for holding programs is constituted by a flash storage.

The image processor 22 is a part that converts image data into an appropriate electrical signal, and performs processing suitable for output, such as enlargement and reduction.

The communicator 23 is a part that communicates with the digital multifunction peripheral 1 via the network 3, and transmits and receives various information such as print data.

The display 24 is a part that displays various information of the user terminal 2.

The display 24 is configured by, for example, a CRT display, a liquid crystal display, an EL display, or the like, and is a display device such as a monitor or line display for an operating system or application software to display electronic data, such as a processing state.

The controller 20 displays the operation and state of the user terminal 2 through the display 24.

The operation acceptor 25 is an interface for operating the user terminal 2, and is a part that accepts commands from the user.

Note that the display 24 and the operation acceptor 25 may be configured by a display panel made of a liquid crystal panel or the like, and a capacitive-type touch panel or the like that is arranged superimposed on the display panel and detects the position where a finger is touched.

### <Print Job Transmission Processing to Digital Multifunction Peripheral 1 in Printer Driver of User Terminal 2 According to Embodiment 1 of Present Disclosure>

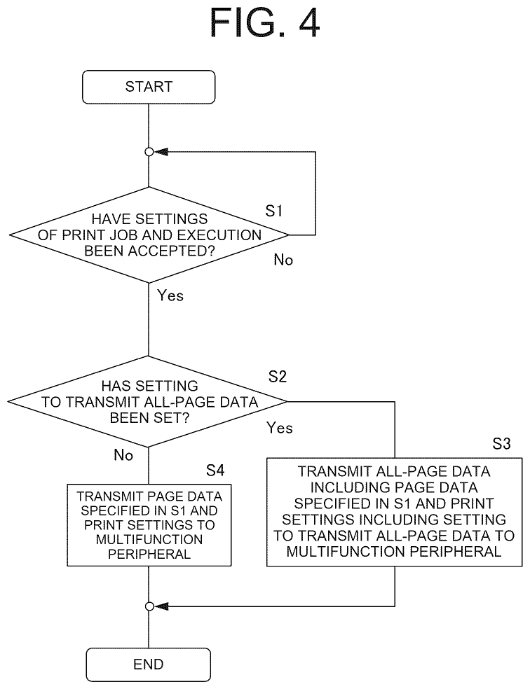

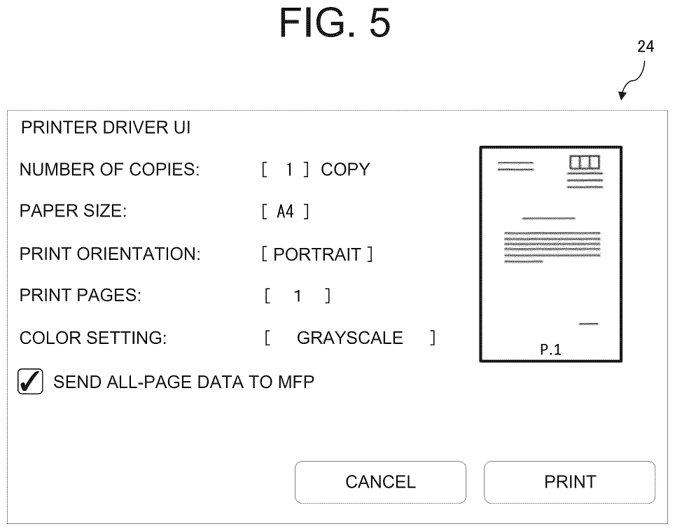

Next, the flow of print job (print command) transmission processing to the digital multifunction peripheral 1 in the printer driver of the user terminal 2 according to Embodiment 1 of the present disclosure will be described based on FIGS. 4 and 5.

FIG. 4 is a flowchart showing an example of transmission processing of a print job to the digital multifunction peripheral 1 in a printer driver of the user terminal 2 in FIG. 1.

In step S1 of FIG. 4, the controller 20 of the user terminal 2 determines whether or not the settings of a print job and execution have been accepted in the printer driver (step S1).

If the settings of a print job and execution have not been accepted (a determination of No in step S1), the controller 20 returns the processing to the determination in step S1.

On the other hand, if the settings of a print job and execution have been accepted (a determination of Yes in step S1), in step S2, the controller 20 determines whether or not a setting to transmit all-page data has been set in the printer driver (step S2).

FIG. 5 is an explanatory diagram showing an example of a print setting screen of the printer driver displayed on the display 24 of the user terminal shown 2 in FIG. 1.

In the example of FIG. 5, print settings such as “Number of copies: [1] copy”, “Paper Size: A4”, “Print orientation: [Portrait]”, “Print Pages: [1]”, “Color Setting: [Grayscale]”, and a print preview screen are displayed on the display 24 as a printer driver UI.

Furthermore, a setting item “Send all-page data to MFP” with a checkbox is displayed on the display 24.

After setting the print settings, the user executes the print job with respect to the digital multifunction peripheral 1 by pressing the “Print” button at the bottom of the screen. Also, the user can cancel the screen display of the printer driver by pressing the “Cancel” button.

If the setting to transmit the all-page data has been set in the printer driver (a determination of Yes in step S2), in step S3, the controller 20 transmits the all-page data including the page data specified in step S1, and print settings including the setting to transmit the all-page data, to the digital multifunction peripheral 1 (step S3), and ends the processing.

On the other hand, if the setting to transmit the all-page data has not been set in the printer driver (a determination of No in step S2), in step S4, the controller 20 transmits the page data specified in step S1 and the print settings to the digital multifunction peripheral 1 (step S4), and ends the processing.

### <Printing Processing of Digital Multifunction Peripheral 1>

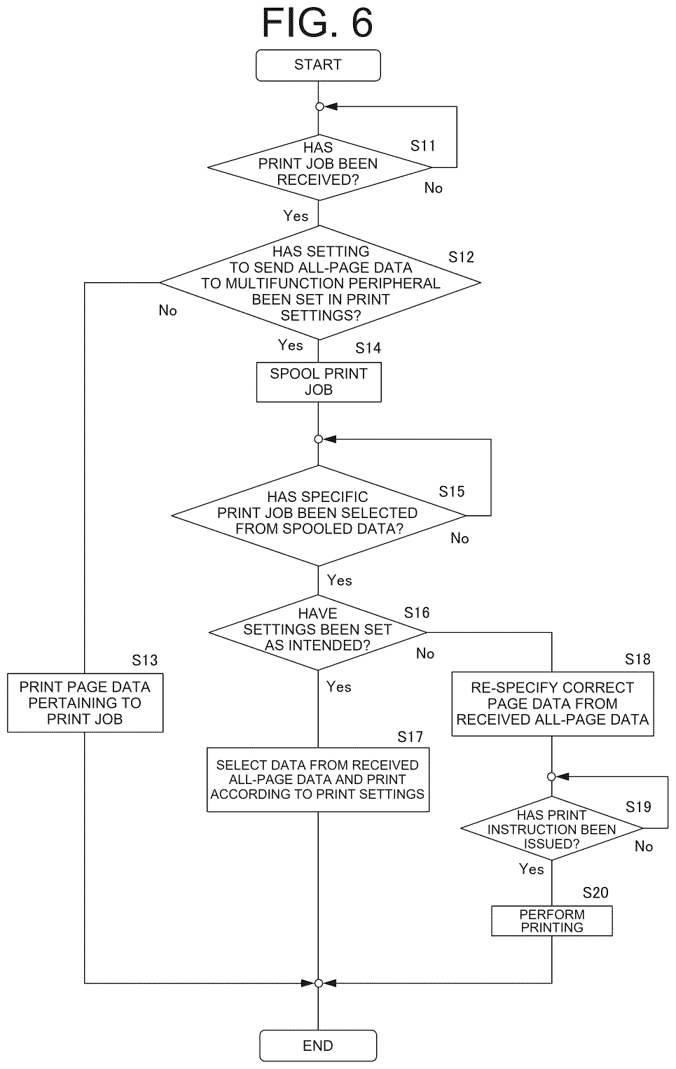

Next, the flow of the printing processing of the digital multifunction peripheral 1 according to Embodiment 1 of the present disclosure will be described based on FIGS. 6 to 13.

FIG. 6 is an explanatory diagram showing an example of printing processing in the digital multifunction peripheral shown in FIG. 1.

In step S11 of FIG. 6, the controller 10 of the digital multifunction peripheral 1 determines whether or not a print job has been received (step S11).

If a print job has not been received (a determination of No in step S11), the controller 10 continues the determination in step S11.

On the other hand, if a print job has been received (a determination of Yes in step S11), in step S12, the controller 10 determines whether or not a setting to the send all-page data to the multifunction peripheral has been set in the print settings (step S12).

If the setting to send the all-page data to the multifunction peripheral is not set in the print settings (a determination of No in step S12), in step S13, the controller 10 prints the page data pertaining to the print job (step S13), and ends the processing.

On the other hand, if the setting to send the all-page data to the multifunction peripheral is set in the print settings (a determination of Yes in step S12), in step S14, the controller 10 causes the storage 13 to store the print job in the spool area (step S14).

Note that, when the remaining capacity of the spool area becomes less than a predetermined capacity, the processing of step S13 may be performed even if the print job includes the all-page data, in order to reduce the system load. Furthermore, in this case, an indication that the remaining capacity of the spool area has become low may be displayed on the display 171.

Next, in step S15, the controller 10 determines whether or not a specific print job has been selected from the spooled data (step S15).

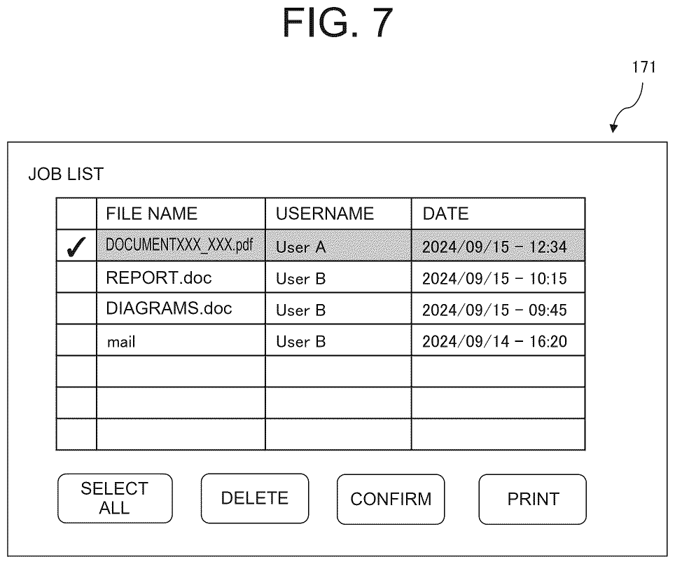

FIG. 7 is an explanatory diagram showing an example of a print job list displayed on the display 171 of the digital multifunction peripheral 1 shown in FIG. 1.

As shown in FIG. 7, a list of print jobs received by the digital multifunction peripheral 1 is displayed on the display 171.

In the example of FIG. 7, a print job for the file name “DocumentXXX.XXXX.pdf” received from the username “User A” is selected. In addition, “Print”, “Confirm”, “Delete”, and “Select All” buttons are displayed at the bottom of the screen.

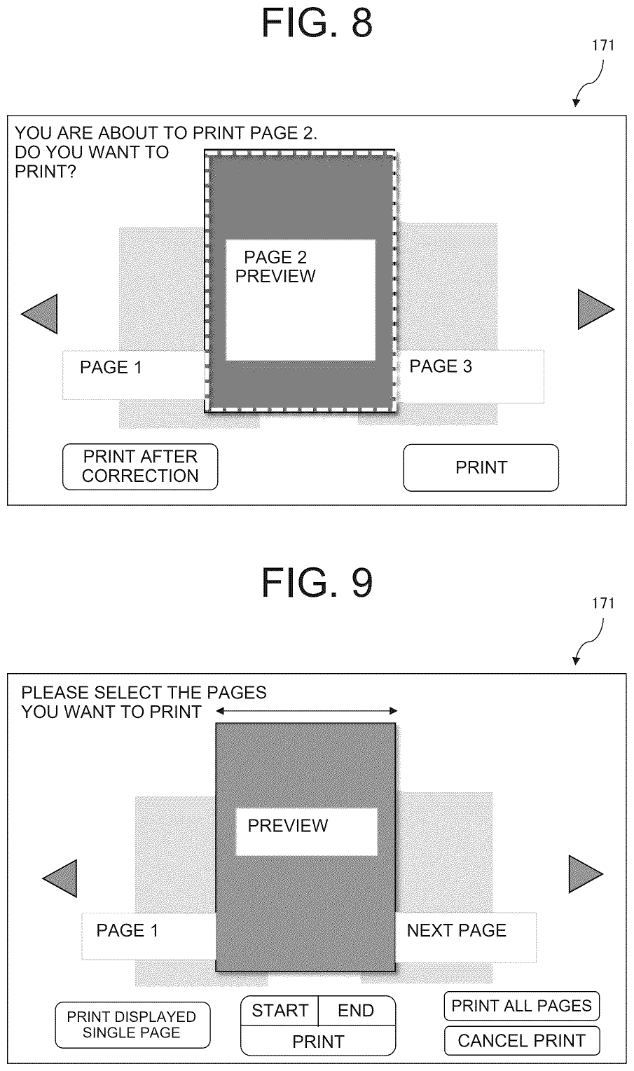

When the user selects the “Confirm” button, the preview screen (described later) shown in FIG. 8 can also be displayed for the selected print job on the display 171.

In the determination of step S15 in FIG. 6, if a job has not been selected from the spooled data (a determination of No in step S15), the controller 10 continues the determination in step S15.

On the other hand, if a specific print job has been selected from the spooled data (a determination of Yes in step S15), in step S16, the controller 10 determines whether or not the print settings have been set as intended (step S16).

As a specific determination method, in a case where the user selects a specific job from the spooled data and selects the “Confirm” button, the controller 10 causes the display 171 to display a preview screen. Then, when a print command is accepted from the user, the controller 10 determines that the print settings have been set as intended. On the other hand, when a correction command is accepted from the user, the controller 10 determines that the print settings have not been set as intended.

FIG. 8 is an explanatory diagram showing an example of a preview screen displayed on the display 171 of the digital multifunction peripheral 1 shown in FIG. 1.

In the example of FIG. 8, a message “You are about to print page 2. Do you want to print?” is displayed along with a preview showing only the second page out of three pages selected.

If there is no problem with the print settings, the user selects the “Print” button at the bottom of the screen.

On the other hand, if the user wishes to correct the print settings, the user selects the “Print after Correction” button.

In step S16 of FIG. 6, if the print settings have been set as intended (a determination of Yes in step S16), in step S17, the controller 10 selects the page data selected by the user from the received all-page data, causes the image former 12 to print according to the print settings (step S17), and ends the processing.

On the other hand, if the print settings have not been set as intended (a determination of No in step S16), in step S18, the controller 10 causes the user to re-specify the correct page data from the received all-page data (step S18).

FIG. 9 is an explanatory diagram showing an example of a print setting correction screen displayed on the display 171 of the digital multifunction peripheral 1 shown in FIG. 1.

In the example of FIG. 9, a print setting correction screen is displayed on the display 171 along with the message “Please select the pages you want to print”.

If the user wants to print only the single page displayed in the center of the preview screen, the user selects the “Print Displayed Single Page” button at the bottom left of the screen.

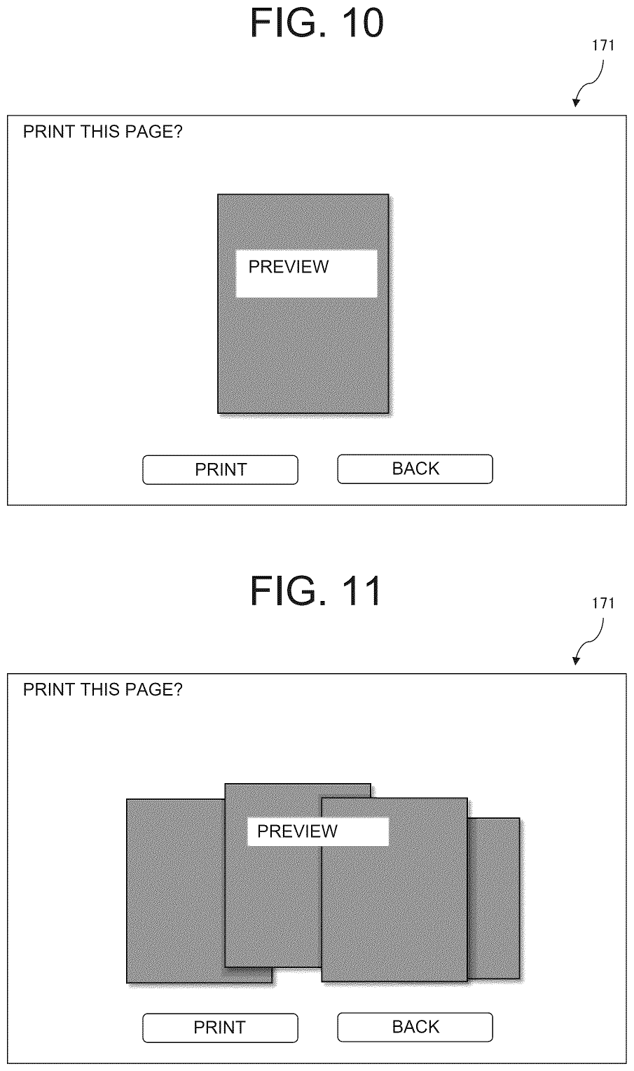

FIG. 10 is an explanatory diagram showing an example of a confirmation screen for single-page printing in the print setting correction screen displayed on the display 171 of the digital multifunction peripheral 1 shown in FIG. 1.

In the example of FIG. 10, a preview with one page selected is displayed along with the message “Print this page?”. If the user wants to print with these settings, the user selects the “Print” button, and if the user wants to return to the print setting correction screen, the user selects the “Back” button.

Also, in FIG. 9, if the user wants to print all pages, the user can also select the “Print All Pages” button at the bottom right of the screen.

If the user wants to cancel printing, the user can also select the “Cancel Print” button at the bottom right of the screen.

FIG. 11 is an explanatory diagram showing an example of a confirmation screen for all-pages printing in the print setting correction screen displayed on the display 171 of the digital multifunction peripheral 1 shown in FIG. 1.

In the example of FIG. 11, a preview with all pages selected is displayed along with the message “Print these pages?”. If the user wants to print with these settings, the user selects the “Print” button, and if the user wants to return to the print setting correction screen, the user selects the “Back” button.

Furthermore, in FIG. 9, if the user wants to print only specific pages among of all pages, the user presses the left and right arrow buttons to move through the preview pages, selects the “Start” button at the bottom center of the screen on the desired page to start printing, and selects the “End” button at the bottom center of the screen on the desired page to end printing. Then, the user selects the “Print” button at the bottom center of the screen.

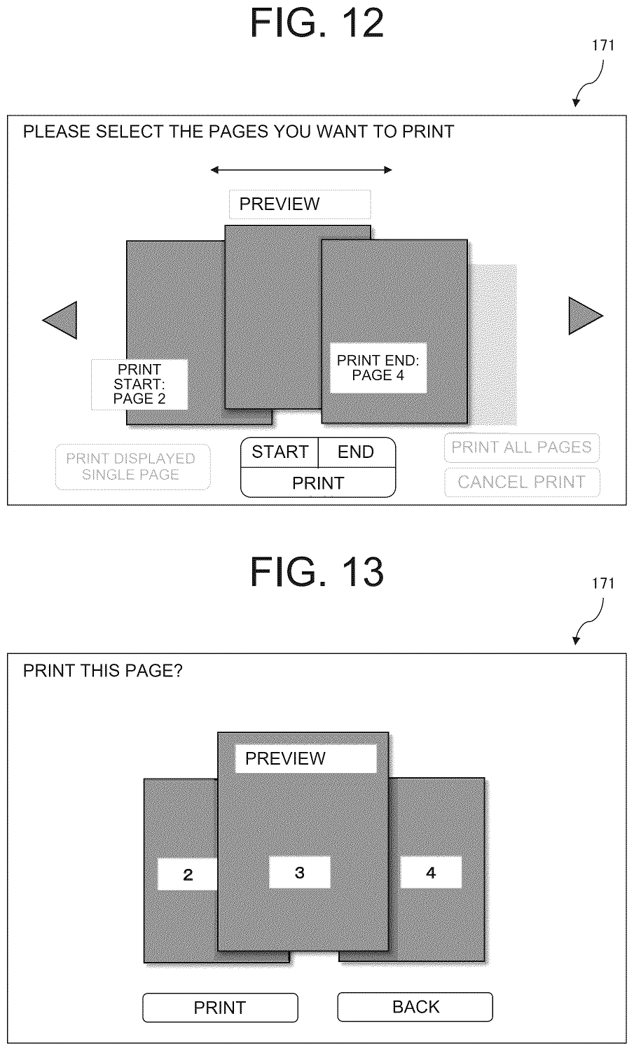

FIG. 12 is an explanatory diagram showing an example of selecting a print start page and a print end page in the print setting correction screen displayed on the display 171 of the digital multifunction peripheral 1 shown in FIG. 1.

In the example of FIG. 12, the user has selected the second page as the print start page and the fourth page as the print end page. Here, if the user selects the print button, a confirmation screen is displayed.

FIG. 13 is an explanatory diagram showing an example of a confirmation screen for printing a specific page in the print setting correction screen displayed on the display 171 of the digital multifunction peripheral 1 shown in FIG. 1.

In the example of FIG. 13, a preview with the second page to the fourth page selected is displayed along with the message “Print these pages?”. If the user wants to print with these settings, the user selects the “Print” button, and if the user wants to return to the print setting correction screen, the user selects the “Back” button.

Next, in step S19 of FIG. 6, the controller 10 determines whether or not a print instruction has been issued (step S19).

If there is no print instruction (a determination of No in step S19), the controller 10 returns the processing to the determination in step S19.

On the other hand, if a print instruction has been issued (a determination of Yes in step S19), in step S20, the controller 10 causes the image former 12 to print the specified pages (step S20), and ends the processing.

As a result, when the digital multifunction peripheral 1 receives a print command, in a case where the all-image data including the image data pertaining to the print command has been received, because a preview screen of the image data is displayed so as to be capable of accepting a correction command for the image data pertaining to the print command, it is possible to realize the image forming system 100, which is capable of more easily correcting a mistake in a print instruction than in a conventional system.

Note that preferred embodiments of the present disclosure also include combinations of any of the plurality of aspects described above.

In addition to the embodiment described above, various modifications can be made to the present disclosure. Such modifications should not be construed as falling outside the scope of the present disclosure. The present disclosure should include meanings equivalent to the claims and all modifications within the scope of the claims.

What is claimed is:

1. An image forming system comprising a user terminal and an image forming device connected via a network, wherein
the user terminal includes
a terminal operation acceptor that accepts a print command issued with respect to the image forming device,
a terminal communicator that transmits image data and print settings pertaining to the print command, and
a terminal controller that controls the terminal operation acceptor and the terminal communicator,
the image forming device includes
a communicator that receives the print command,
an image former that forms an image based on the image data and the print settings pertaining to the print command,
an operation panel that displays various information and accepts a command from a user, and
a controller that controls the communicator, the image former, and the operation panel,
the terminal operation acceptor accepts a setting indicating whether or not to transmit all-image data of a file subjected to printing that includes the image data pertaining to the print command,
the terminal controller, in a case where the terminal operation acceptor has accepted the setting to transmit the all-image data, causes the terminal communicator to transmit the all-image data including the image data pertaining to the print command, and the print settings including the setting to transmit the all-image data, and
the controller, in a case where the print settings received by the communicator include the setting to transmit the all-image data, causes the operation panel to display a preview screen of the image data so as to be capable of accepting a correction command of the image data pertaining to the print command.

2. The image forming system according to claim 1, wherein
the controller, in a case where the communicator has received the all-image data including the image data pertaining to the print command, causes the operation panel to display a preview screen of the image data pertaining to the print command, and
the correction command includes at least one of a page-specifying command of the image data, an all-pages print command of the image data, or a single-page print command of the image data displayed on the preview screen.

3. The image forming system according to claim 1, wherein the image forming device further comprises
a storage that stores all data pertaining to the print command in a predetermined spool area, wherein
the controller, in a case where a remaining capacity of the spool area becomes less than a predetermined capacity, even when the communicator has received the all-image data including the image data pertaining to the print command, causes the image former to form an image based on the image data and the print settings.

4. The image forming system according to claim 1, wherein
the terminal controller, in a case where the all-image data of the file subjected to printing in the print command consists of only one page, even when the terminal operation acceptor has accepted a setting to transmit the all-image data, causes the terminal communicator to transmit only the image data pertaining to the print command.

5. The image forming system according to claim 1, wherein
the user terminal further comprises a terminal display that displays various information, wherein
the terminal operation acceptor, in a case where the all-image data of the file subjected to printing in the print command consists of only one page, does not display, on the terminal display, a setting indicating whether or not to transmit the all-image data of the file subjected to printing that includes the image data pertaining to the print command.

6. The image forming system according to claim 1, wherein
the controller, in a case where the communicator has not received the all-image data including the image data pertaining to the print command, causes the image former to form an image based on the image data pertaining to the print command and the print settings pertaining to the print command.
